(19) United States
(12) Patent Application Publication
(10) Pub. No.: US 2015/0310197 A1
(43) Pub. Date: Oct. 29, 2015

(54) METHOD OF PROCESSING INPUT AND ELECTRONIC DEVICE THEREOF

(71) Applicant: Samsung Electronics Co., Ltd., Gyeonggi-do (KR)

(72) Inventor: Min-Woo OH, Gyeonggi-do (KR)

(21) Appl. No.: 14/697,311

(22) Filed: Apr. 27, 2015

(30) Foreign Application Priority Data
Apr. 25, 2014 (KR) 10-2014-0049854

(51) Int. Cl. G06F 21/32; G06F 3/01

(52) U.S. Cl. CPC G06F 21/32; G06F 3/016

(57) ABSTRACT

A method of operating an electronic device is provided. The method includes detecting a knock on a predetermined area of the electronic device, analyzing a pattern of the detected knock, and performing a function associated with the analyzed pattern.

### PRIORITY

This application claims priority under 35 U.S.C. §119(a) to Korean Patent Application Serial No. 10-2014-0049854 filed in the Korean Intellectual Property Office on Apr. 25, 2014, the entire contents of which are incorporated herein by reference.

### BACKGROUND

1. Field of the Disclosure

The present disclosure relates generally to a method of processing an input and an electronic device thereof.

2. Description of Related Art

With the development of information communication technologies and semiconductor technologies, various electronic devices have been developed as multimedia devices that provide various multimedia services. For example, an electronic device provides various multimedia services, such as a messenger service, a broadcasting service, a wireless Internet service, a camera service, and a music reproduction service.

Recently, as personal privacy becomes more important, a security function, which makes a configuration to lock an electronic device, is enhanced. For example, a variety of locking schemes using a touch screen of an electric device are used, such as a 9 dot pattern scheme, a character recognition scheme, and a shape recognition scheme.

In a conventional locking method using a touch screen, a user inputs a secret code (e.g., a pattern, a password, etc.) using the touch screen, and, when the secret code is used repeatedly, the secret code may be exposed to another person. Additionally, the secret code cannot be input on an area other than a touch screen, and standby power is consumed while receiving input of the secret code.

### SUMMARY

The present disclosure has been made to address at least the above-mentioned problems and/or disadvantages and to provide at least the advantages described below.

Accordingly, an aspect of the present disclosure is to provide a method of processing an input and an electronic device thereof, which provide a locking function having improved convenience and security.

Another aspect of the present disclosure is to provide a method of processing an input and an electronic device thereof, in which standby electric power for a locking function is reduced.

Another aspect of the present disclosure is to provide a method of processing an input and an electronic device thereof, which perform a function associated with a knocking operation together with an entertainment factor.

In accordance with an aspect of the present disclosure, a method of operating an electronic device is provided. The method includes detecting a knock on a predetermined area of the electronic device, analyzing a pattern of the detected knock, and performing a function associated with the analyzed pattern.

In accordance with another aspect of the present disclosure, an electronic device is provided. The electronic device includes an acceleration sensor module, a microphone module, and a processor configured to analyze a pattern of a knock, detected by at least one of the acceleration sensor module and the microphone module, to perform a function associated with the pattern.

In accordance with another aspect of the present disclosure, a non-transitory computer-readable recording medium for storing a program for performing a method is provided. The method includes detecting a knock on a predetermined area of the electronic device, analyzing a pattern of the detected knock, and performing a function associated with the analyzed pattern.

### BRIEF DESCRIPTION OF THE DRAWINGS

The above and other aspects, features, and advantages of embodiments of the present disclosure will be more apparent from the following detailed description taken in conjunction with the accompanying drawings, in which:

FIG. 1 is a block diagram of an electronic device, according to an embodiment of the present disclosure;

FIG. 2 is a block diagram of a knock processing module of an electronic device, according to an embodiment of the present disclosure;

FIG. 3 illustrates graphs for comparing a knock pattern detected by an electronic device, according to an embodiment of the present disclosure;

FIG. 4 is a flowchart illustrating a process of performing a function associated with a pattern of knocks detected in an electronic device, according to an embodiment of the present disclosure;

FIGS. 5A, 5B and 5C illustrate states in which a knock is detected in an electronic device, according to an embodiment of the present disclosure;

FIGS. 6A, 6B and 6C illustrate screens for performing a function associated with a pattern of knocks detected in an electronic device, according to an embodiment of the present disclosure;

FIGS. 7A and 7B illustrate screens for performing a function associated with a pattern of knocks detected in an electronic device, according to an embodiment of the present disclosure;

FIGS. 8A and 8B illustrate screens for performing a function associated with a pattern of knocks detected in an electronic device, according to an embodiment of the present disclosure;

FIG. 9 is a flowchart illustrating a process of registering a pattern of knocks in an electronic device, according to an embodiment of the present disclosure;

FIG. 10 is a flowchart illustrating a process of performing a function associated with a pattern of knocks detected in an electronic device according to an embodiment of the present disclosure; and

FIG. 11 is a block diagram illustrating an electronic device according to various embodiments of the present disclosure.

### DETAILED DESCRIPTION

Hereinafter, various embodiments of the present disclosure will be described with reference to the accompanying drawings. The present disclosure may be modified in various forms and include various embodiments, but specific examples are illustrated in the drawings and described in the description. However, the description is not intended to limit the present disclosure to the specific embodiments, and it shall be appreciated that all changes, equivalents and substitutions belonging to the idea and technical scope of the present disclosure are included in the present disclosure. In the description of the drawings, identical or similar reference numerals are used to designate identical or similar elements.

The terms “include” or “may include” refer to the existence of a corresponding disclosed function, operation or component which can be used in various embodiments of the present disclosure and does not limit one or more additional functions, operations, or components. Further, the terms “include”, “have” and their conjugates may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

In various embodiments of the present disclosure, the expressions “or” or “at least one of A or/and B” include any or all of combinations of words listed together. For example, the expression “A or B” or “at least A or/and B” may include A, may include B, or may include both A and B.

The expressions “1”, “2”, “first”, or “second” used in various embodiments of the present disclosure may modify various components of various embodiments but do not limit the corresponding components. For example, the above expressions do not limit the sequence and/or importance of the corresponding elements. The above expressions may be used merely for the purpose of distinguishing one element from the other elements. For example, a first electronic device and a second electronic device indicate different electronic devices although both of them are electronic devices. For example, without departing from the scope of the present disclosure, a first component element may be referred to as a second component element. Similarly, the second component element also may be referred to as the first component element.

When an element is referred to as being “coupled” or “connected” to any other element, it should be understood that not only the element may be directly coupled or connected to the other element, but also a third element may be interposed between the two elements. Contrarily, when an element is referred to as being “directly coupled” or “directly connected” to any other element, it should be understood that no other element is interposed between the two elements.

In the present disclosure, the terms are used to describe a specific embodiment, and are not intended to limit the present disclosure. As used herein, the singular forms are intended to include the plural forms as well, unless the context clearly indicates otherwise.

Unless defined differently, all terms used herein, which include technical terminologies or scientific terminologies, have the same meaning as a person skilled in the art to which the present disclosure belongs would understand them to have. Such terms as those defined in a generally used dictionary are to be interpreted to have the meanings equivalent to the contextual meanings in the relevant field of art, and are not to be interpreted to have ideal or excessively formal meanings unless clearly defined in such a manner in the present disclosure.

An electronic device according to various embodiments of the present disclosure may be a device with a communication function. For example, the electronic device may include at least one of a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), an MP3 player, a mobile medical device, a camera, a wearable device (for example, a Head-Mounted-Device (HMD) such as electronic glasses, electronic clothes, an electronic bracelet, an electronic necklace, an electronic accessory, an electronic tattoo, and a smart watch).

According to an embodiment, an electronic device may be a smart home appliance with a communication function. The smart home appliance, as an example of the electronic device, may include at least one of, for example, a television, a Digital Video Disk (DVD) player, an audio system, a refrigerator, an air conditioner, a vacuum cleaner, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, and an electronic picture frame.

According to an embodiment, the electronic device may include at least one of various types of medical devices (for example, Magnetic Resonance Angiography (MRA), Magnetic Resonance Imaging (MRI), Computed Tomography (CT), a scanning machine, ultrasonic wave device and the like), a navigation device, a Global Positioning System (GPS) receiver, an Event Data Recorder (EDR), a Flight Data Recorder (FDR), a car infotainment device, ship electronic equipment (for example, navigation equipment for a ship, a gyro compass and the like), avionics, a security device, and an industrial or home robot.

According to an embodiment, the electronic devices may include at least one of furniture or a part of a building/structure having a communication function, electronic boards, electronic signature receiving devices, projectors, or various measuring equipment (e.g., equipment for a water supply, electricity, gases or radio waves).

An electronic device according to various embodiments of the present disclosure may be a combination of one or more of above described various devices. Also, an electronic device according to various embodiments of the present disclosure may be a flexible device. Also, an electronic device according to various embodiments of the present disclosure is not limited to the above described devices.

Hereinafter, an electronic device according to various embodiments of the present disclosure will be described with reference to the accompanying drawings. In various embodiments, the term “user” may indicate a person using an electronic device or a device (e.g. an artificial intelligence electronic device) using an electronic device.

The term “knock” used in various embodiments refers to an operation of knocking an electronic device and generating sound or vibration, and may include, for example, a tapping operation.

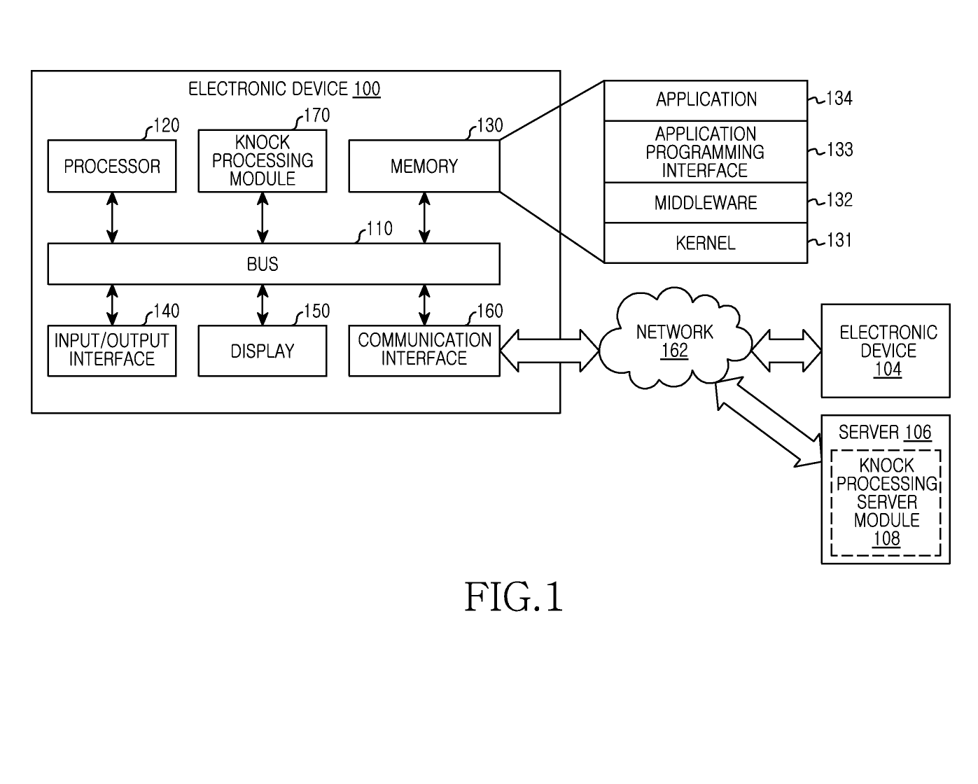

A method of processing an input and an electronic device thereof according to various embodiments of the present disclosure, provides a locking function which has improved convenience and security, reduces consumption of standby electric power for a locking function, and provides a user interface which can perform a function associated with a knocking operation together with an entertainment factor. FIG. 1 is a block diagram of an electronic device, according to an embodiment of the present disclosure.

Referring to FIG. 1, an electronic device 100 may include a bus 110, a processor 120, a memory 130, an input/output interface 140, a display 150, a communication interface 160, and a knock processing module 170. According to an embodiment, the knock processing module 170 can be operated while being included in the processor 120 or can interwork with the processor 120 while being included in a separate module.

The bus 110 may be a circuit which interconnects the above-described elements and transfers communications (e.g., a control message) between the above-described elements.

The processor 120 can, for example, receive a command from other component elements (e.g., the memory 130, the input/output interface 140, the display 150, the communication interface 160, the knock processing module 170, etc.), through the bus 110, can decrypt the received command, and may execute an operation or data processing according to the decrypted command.

The memory 130 can store a command or data, which is received from the processor 120 or other elements (e.g., the input/output interface 140, the display 150, the communication interface 160, the knock processing module 170, etc.), or is generated by the processor 120 or the other elements.

The memory 130 may include programming modules, such as a kernel 131, a middleware 132, an Application Programming Interface (API) 133, an application 134, etc. The programming modules, as described above may be formed of software, firmware, and hardware, or a combination of two or more of them.

The kernel 131 can control or manage system resources (e.g., the bus 110, the processor 120, the memory 130, etc.) used for executing an operation or a function implemented in other programming modules, e.g., the middleware 132, the API 133, or the application 134. Further, the kernel 131 can provide an interface which enables the middleware 132, the API 133, or the application 134 to access an individual element of the electronic device 100 so as to make a control or management.

The middleware 132 can perform intermediation such that the API 133 or the application 134 can receive/transmit data while communicating with the kernel 131. Further, in association with task requests received from the application 134, the middleware 132 can execute a control (e.g., scheduling or load balancing) for a task request, using a method of assigning, to at least one of application 134, a priority of use of a system resource (e.g., the bus 110, the processor 120, the memory 130, etc.) of the electronic device 100.

The API 133 is an interface used by the application 134 to control a function provided from the kernel 131 or the middleware 132, and may include, for example, at least one interface or function (e.g., a command) for file control, window control, image processing, character control, etc.

The application 134 may include an SMS/MMS application, an e-mail application, a calendar application, an alarm application, a health care application (e.g., an application for measuring an amount of exercise or blood sugar), and an environmental information application (e.g., an application for providing an atmospheric pressure, humidity information, temperature information, etc.). Additionally or alternatively, the application 134 may be an application relating to the exchange of information between the electronic device 100 and an external electronic device 104. The application relating to the exchange of information may include, for example, a notification relay application for transferring specific information to an external electronic device 104 or a device management application for managing an external electronic device.

For example, the notification relay application may include a function of transferring, to the external electronic device 104, notification information generated from other applications (e.g., an SMS/MMS application, an e-mail application, a health management application, an environmental information application, etc.) of the electronic device 100. Additionally or alternatively, the notification relay application may receive notification information from, for example, an external electronic device 104, and may provide the notification information to a user.

The device management application manages (e.g., installs, deletes, or updates), for example, a function of at least a part of an external electronic device 104 that communicates with the electronic device 100 (e.g., turning on/off the external electronic device (or a few component) or adjusting brightness (or resolution) of a display), an application operated in the external electronic device 104, or a service provided from the external electronic device 104 (e.g. a call service or a message service).

The application 134 may include an application designated according to an attribute (e.g., a type of the electronic device) of an external electronic device 104. For example, when the external electronic device 104 is an MP3 player, the application 134 may include an application related to the reproduction of music. Similarly, when the external electronic device 104 is a mobile medical device, the application 134 may include an application related to health care. The application 134 may include at least one of applications received from an application designated to the electronic device 100 or an application received from an external electronic device 104.

The input/output interface 140 transfers a command or data input by a user through an input/output device (e.g., a sensor, a keyboard, or a touch screen) to the processor 120, the memory 130, the communication interface 160, and the knock processing module 170 through, for example, the bus 110. For example, the input/output interface 140 may provide, to the processor 120, data for a user's touch input through a touch screen. Further, the input/output interface 140 may output, for example, a command or data received through the bus 110 from the processor 120, the memory 130, the communication interface 160, and the knock processing module 170, through an input/output device (e.g., a speaker or display). For example, the input/output interface 140 may output voice data processed by the processor 120 to the user through a speaker.

The display 150 may display various pieces of information (e.g., multimedia data, text data, etc.) to a user.

The communication interface 160 may control communication between the electronic device 100 and the external electronic device 104 or the server 106. For example, the communication interface 160 may be connected to the network 162 through wireless communication or wired communication to communicate with an external device.

The wireless communication may include at least one of, for example, Wi-Fi, Bluetooth (BT), Near Field Communication (NFC), Global Positioning System (GPS) and cellular communication (e.g., Long Term Evolution (LTE), LTE-A, Code Division Multiple Access (CDMA), Wideband CDMA (WCDMA), Universal Mobile Telecommunication System (UMTS), Wireless Broadband (WiBro), and Global System for Mobile communication (GSM)).

The wired communication may include at least one of, for example, a Universal Serial Bus (USB), a High Definition Multimedia Interface (HDMI), a Recommended Standard 232 (RS-232), and a Plain Old Telephone Service (POTS).

The network 162 may be a communication network. The communication network may include at least one of a computer network, the Internet, the Internet of Things, and a telephone network. A protocol (e.g. a transport layer protocol, a data link layer protocol, or a physical layer protocol) for the communication between the electronic device 100 and the external device 104 may be supported by at least one of the application 134, the application programming interface 133, the middleware 132, the kernel 131, and the communication interface 160.

The knock processing module 170 can perform a function associated with a pattern of knocks detected in a predetermined area of the electronic device 100. The knock processing module 170 can control to detect a pattern of knocks through an acceleration sensor module and a microphone module and perform a specific function when the detected pattern of the knock corresponds to a reference pattern of knocks.

The server 106 can perform at least one of the operations (or functions) executed in the electronic device 100 so as to support driving of the electronic device 100. For example, the server 106 may include a knock processing server module 108 which can support the knock processing module 170 implemented in the electronic device 100.

The knock processing server module 108 may include at least one element of the knock processing module 170 so as to perform (e.g., execute) at least one of the operations performed by the knock processing module 170.

The knock processing module 170 can process at least some information acquired from other elements (e.g. the processor 120, the memory 130, the input/output interface 140, the communication interface 160, etc.) and may provide the processed information to a user in various schemes. For example, the knock processing module 170 can control at least a part of the electronic device 100 such that the electronic device 100 interworks with the electronic device 104 and the server 106 using (or independently of) the processor 120. According to an embodiment, at least one element of the knock processing module 170 is included in the server 106 (e.g., the knock processing server module 108) and may receive support of at least one operation implemented by the knock processing module 170 from the server 106.

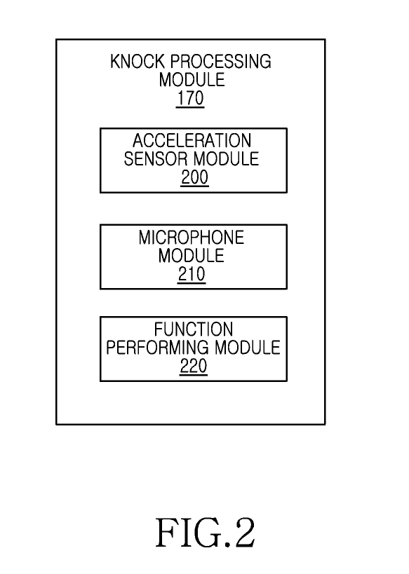

FIG. 2 is a block diagram of a knock processing module of an electronic device, according to an embodiment of the present disclosure.

Referring to FIG. 2, the knock processing module 170 may include an acceleration sensor module 200, a microphone module 210, and a function performing module 220.

The acceleration sensor module 200 can detect contact, collision, or shock with an object, in a predetermined area of the electronic device 100, so as to detect a pattern of knocks. The knock may be detected in an idle state of the electronic device 100. The detected pattern of knocks may include at least one of the number of knocks, the period of the knocks, and the intensity of the knocks. The acceleration sensor module 200 may acquire acceleration information at the time of contact, collision, or shock between the electronic device 100 and an object. The acceleration sensor module 200 can detect an acceleration, a rotating angle, vibration, an amplitude (displacement), etc. of the electronic device 100 and include a 3-axis acceleration sensor to which an application principle of an inertial force, an electrical strain, and a gyro is applied.

The microphone module 210 can detect sound waves generated due to vibrations resulting from contacts, collisions, or shocks with an object, in a predetermined area of the electronic device 100, so as to detect a pattern of knocks. The detected pattern of knocks may include at least one of the number of knocks, the period of the knocks, and the intensity of the knocks. The microphone module 210 can acquire sound information according to sound waves generated by a vibration.

The function performing module 220 can perform a specific function by comparing acceleration information and sound information according to the detected pattern of knocks with reference acceleration information and reference sound information which are pre-registered. For example, when the acquired acceleration information and the acquired sound information correspond to the reference acceleration information and the reference sound information at a threshold ratio or higher, the function performing module 220 can perform a function associated with the detected pattern of knocks. Such a function may include, for example, a lock screen releasing function, a call reception/transmission function, a specific application executing function, etc. The function performing module 220 can configure a function which receives a knock pattern to be registered and is associated with the knock pattern to be registered.

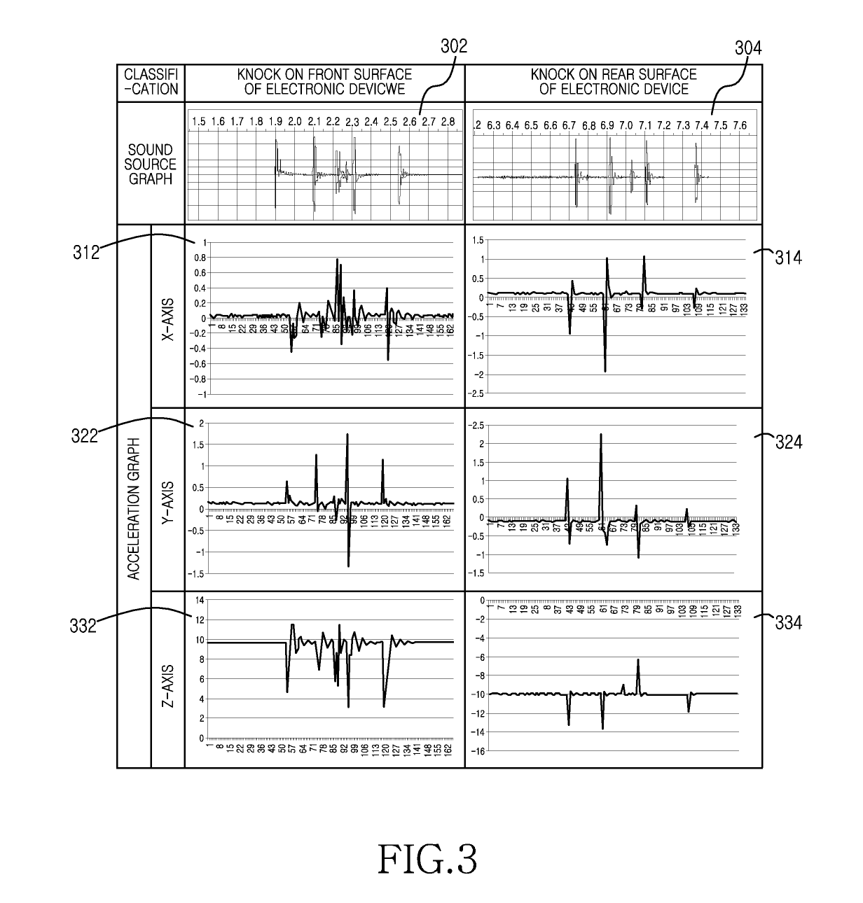

FIG. 3 illustrates graphs for comparing a knock pattern detected by an electronic device, according to an embodiment of the present disclosure.

Referring to FIG. 3, acceleration information and sound information acquired through the acceleration sensor module 200 and the microphone module 210 can be illustrated in a sound source graph and an acceleration graph. For example, a sound source graph 302 according to a knock pattern detected on the front surface of the electronic device 100 may be different from a sound source graph 304 according to a knock pattern detected on the rear surface of the electronic device 100. Further, acceleration graphs 312, 322, and 332 according to the knock pattern detected on the front surface of the electronic device 100 may be different from acceleration graphs 314, 324, and 334 according to the knock pattern detected on the rear surface of the electronic device 100. The function performing module 220 can perform a comparison of the graphs by combining the sound source graph 302 with at least one of the X-axis acceleration graph 312, the Y-axis acceleration graph 322, and the Z-axis acceleration graph 332.

An electronic device according to various embodiments may include an acceleration sensor module, a microphone module, and a processor which analyzes a pattern of knocks detected through the acceleration sensor module and the microphone module so as to perform a function associated with the pattern.

According to various embodiments, the processor can control to detect at least one of the number of the knock, the period of the knock, and the intensity of the knock.

According to various embodiments, the processor can control to detect the knock in an idle state of the electronic device.

According to various embodiments, the processor can determine whether the pattern of a knock corresponds to a reference pattern of a knock.

According to various embodiments, the processor can determine whether acceleration information and sound information of the pattern of a knock corresponds to the reference acceleration information and reference sound information of the knock pattern.

According to various embodiments, the processor can determine whether the pattern of a knock corresponds to the reference pattern of a knock at a threshold ratio or higher.

According to various embodiments, the function may include at least one of a lock screen releasing function, a call reception/transmission function, a specific application executing function, etc.

According to various embodiments, the processor can receive a pattern of a knock to be registered and configure a function associated with the pattern of a knock to be configured. The knock processing module 170 may be implemented in a processor.

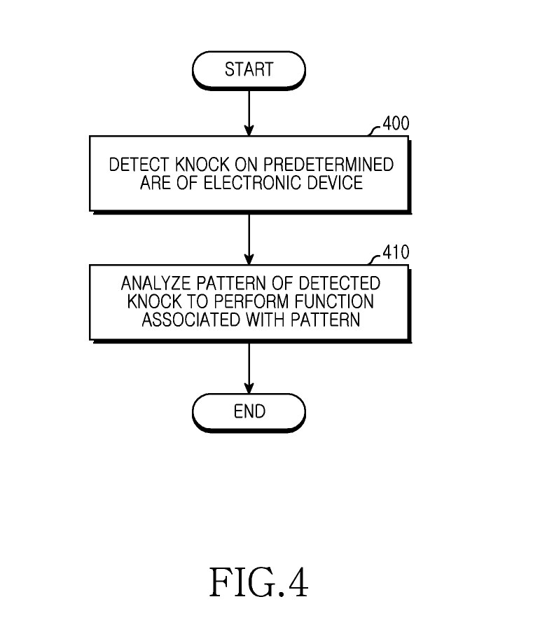

FIG. 4 is a flowchart illustrating a process of performing a function associated with a pattern of knocks detected in an electronic device, according to an embodiment of the present disclosure.

Referring to FIG. 4, in step 400, an electronic device 100 can detect a knock in a predetermined area of the electronic device 100. The electronic device 100 can detect a contact, collision, or shock with an object, on a predetermined area of the electronic device 100. For example, the electronic device 100 can acquire acceleration information based on a contact, collision, or shock with an object, through an acceleration sensor. The electronic device 100 can detect sound waves generated by vibrations according to the contacts, collisions, or shocks with an object, on a predetermined area of the electronic device 100. For example, the electronic device 100 can acquire sound information based on a sound wave generated by a vibration through a microphone module.

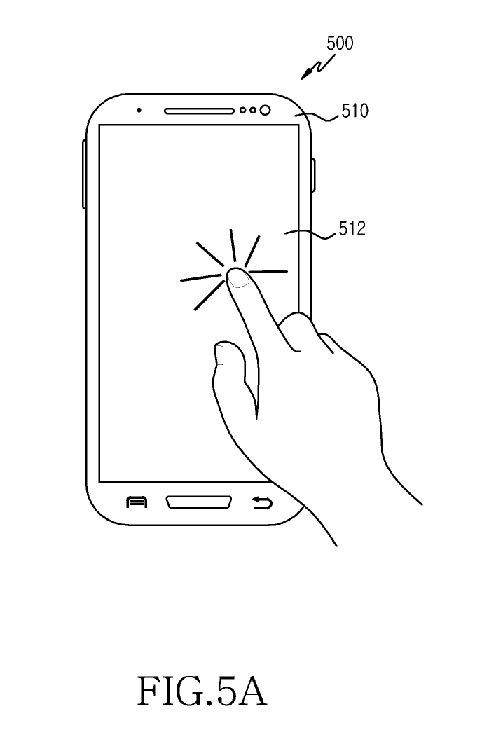

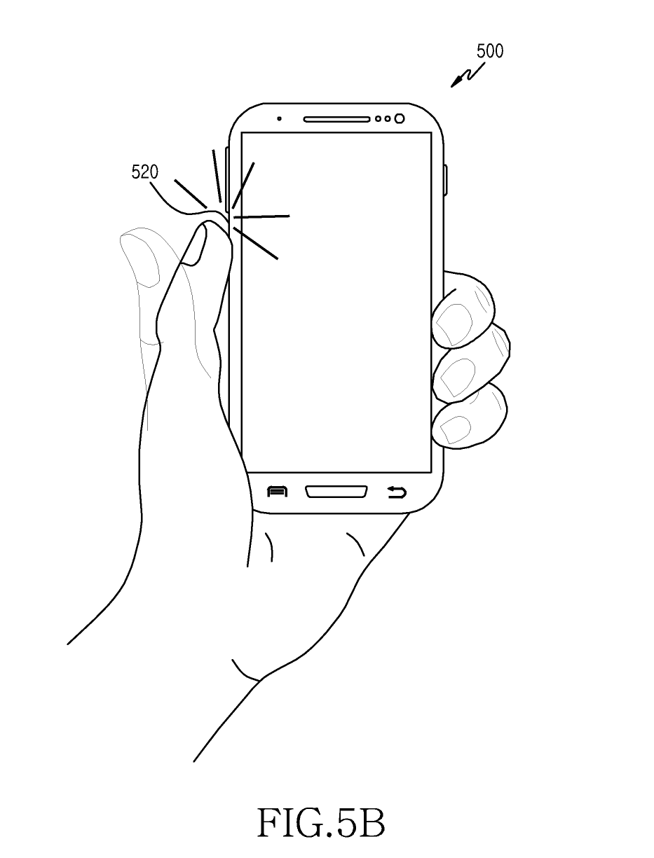

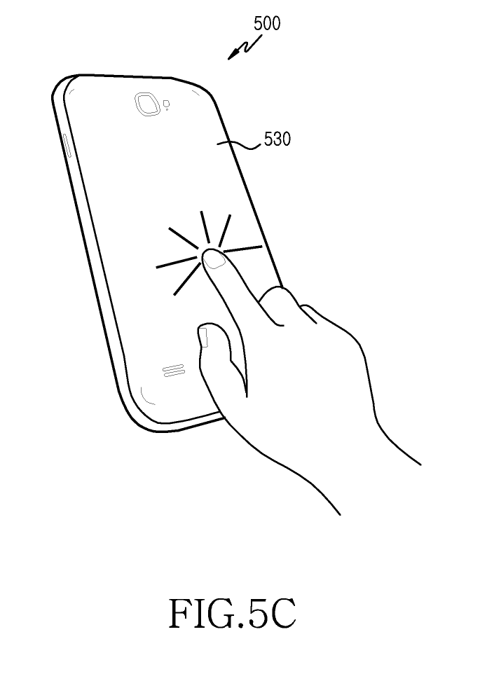

FIGS. 5A, 5B and 5C illustrate states in which a knock is detected in an electronic device, according to an embodiment of the present disclosure.

Referring to FIGS. 5A to 5C, an electronic device 500 can detect a knock on a predetermined area of a side surface 520, a rear surface 530, and optionally on a front surface 510 of the electronic device 500. For example, the electronic device 500 can detect a knock generated on a display area 512 of the front surface 510 of the electronic device 500 or can detect a knock generated on an area other than the display area 512 of the front surface 510 of the electronic device 500, such as on a predetermined area of the side surface 520 and on a predetermined area of the rear surface 530. According to various embodiments, the electronic device 500 can detect a knock generated by a user's finger as well as a knock generated by a predetermined object.

Referring back to FIG. 4, in step 410, the electronic device 100 can analyze a pattern of the detected knock to perform a function associated with the pattern. The electronic device 100 can acquire a knock pattern including at least one of the number of knocks, the period of the knocks, and the intensity of the knocks. The knock pattern may include acceleration information and sound information acquired on the basis of at least one of the number of knocks, the period of the knocks, and the intensity of the knocks. The electronic device 100 can perform a specific function by comparing the acquired knock pattern with a pre-registered reference knock pattern. For example, when the acquired knock pattern corresponds to the reference knock pattern at a threshold ratio or higher, the electronic device 100 can perform a function associated with the acquired knock pattern. Such a function may include a lock screen releasing function, a call transmission/reception function, or a specific application execution function, but is not limited thereto, and may further include various functions to be applied.

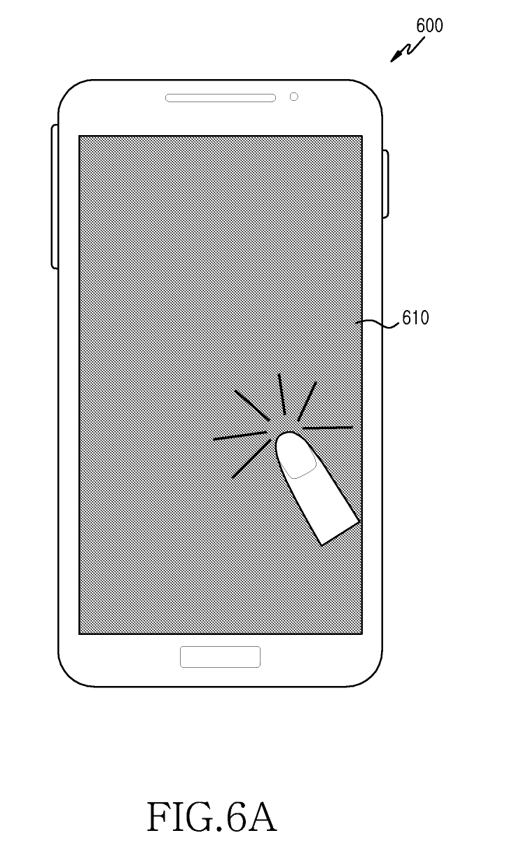

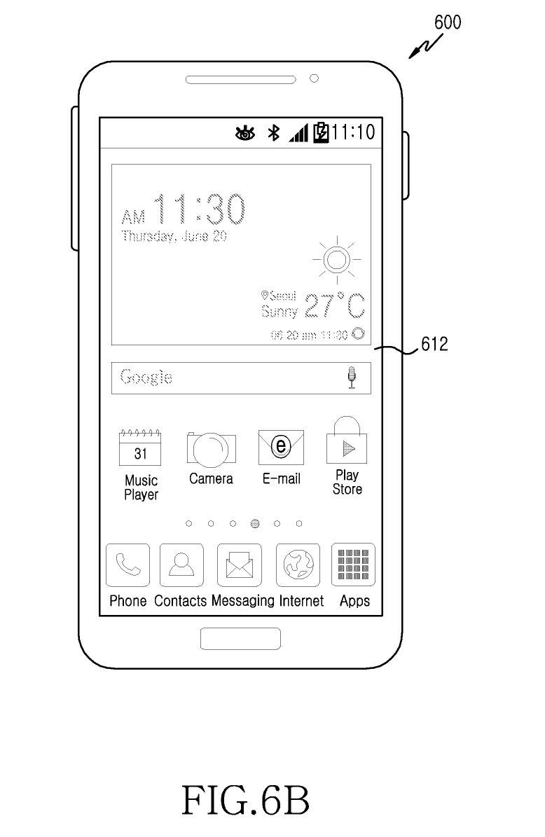

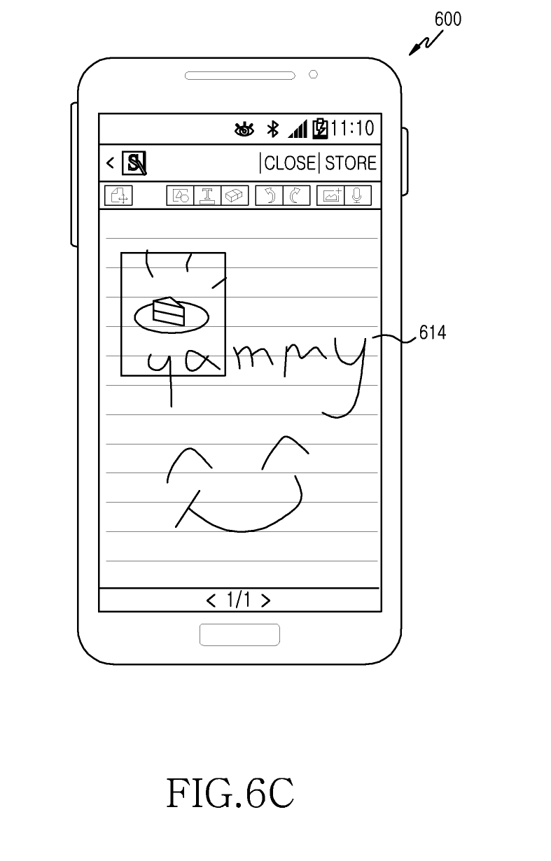

FIGS. 6A, 6B and 6C illustrate screens for performing a function associated with a pattern of knocks detected in an electronic device, according to an embodiment of the present disclosure.

Referring to FIGS. 6A, 6B, and 6C, when a specific knock is detected in an idle state, i.e., in a state in which a display 610 is switched off, as illustrated in FIG. 6A, an electronic device 600 can display a home screen (or a basic screen) 612, as illustrated in FIG. 6B. Alternatively, when a specific knock is detected in an idle state, the electronic device 600 can execute a specific application 614, as illustrated in FIG. 6C. When a specific knock is detected while the home screen (or the basic screen) 612 is displayed, the electronic device 600 can execute the specific application 614. The electronic device 600 can configure a screen to be displayed according to a knock pattern and an application to be executed according to a knock pattern, and can configure a knock pattern for each of the screen and the application.

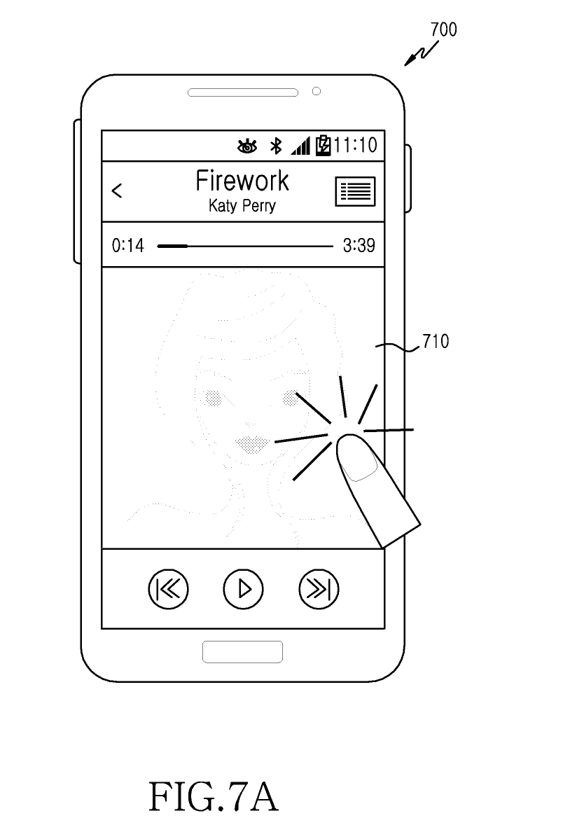

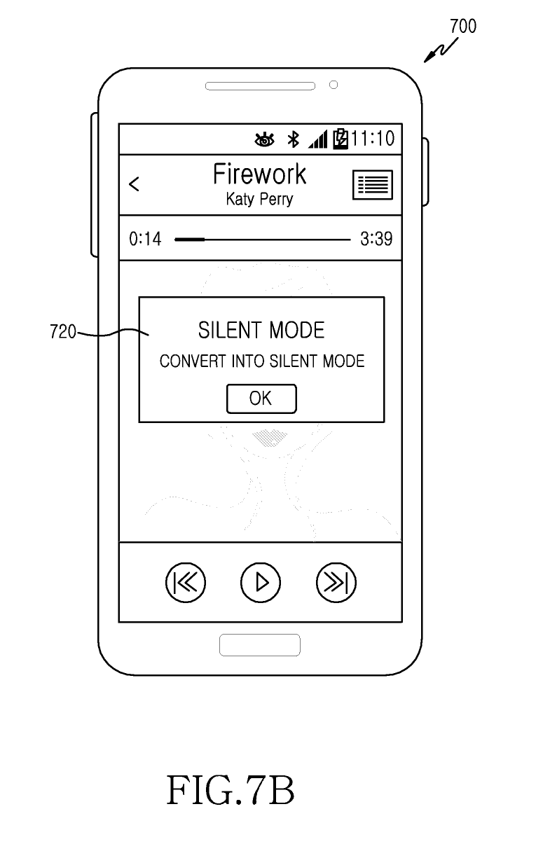

FIGS. 7A and 7B illustrate screens for performing a function associated with a pattern of knocks detected in an electronic device, according to an embodiment of the present disclosure.

Referring to FIGS. 7A and 7B, according to an embodiment of the present disclosure, when a specific knock is detected while a music application 710 is executed, as illustrated in FIG. 7A, an electronic device 700 can convert a mode thereof into a silent mode 720 as illustrated in FIG. 7B. For example, the electronic device 700 can identify a specific knock to stop the reproduction of a piece of music currently being reproduced, to reproduce a piece of music which is currently stopped, to reproduce a next piece of music, or to search for all pieces of music.

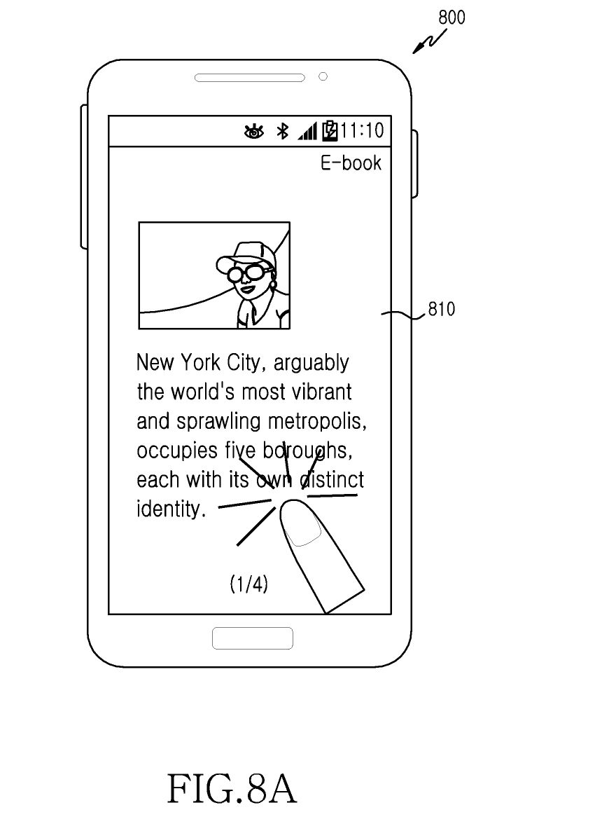

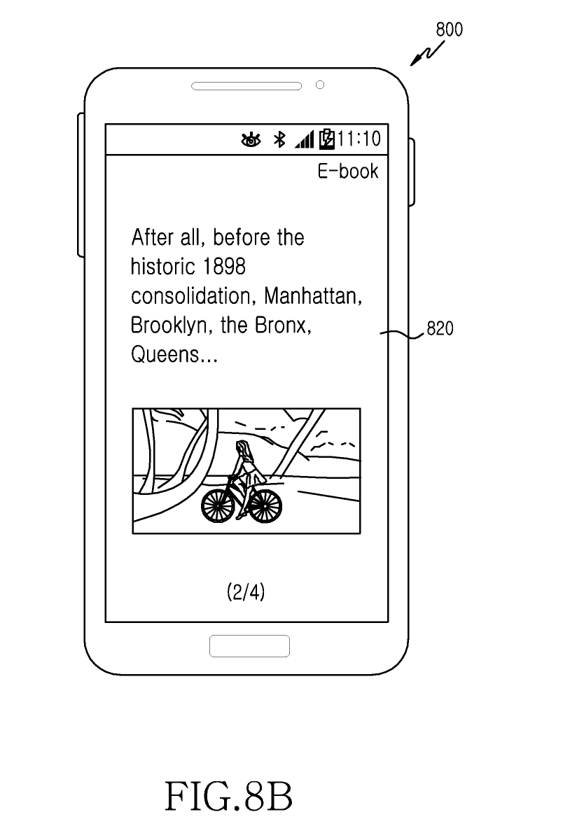

FIGS. 8A and 8B illustrate screens for performing a function associated with a pattern of knocks detected in an electronic device, according to an embodiment of the present disclosure.

Referring to FIGS. 8A and 8B, according to an embodiment of the present disclosure, when a specific knock is detected while an E-book application is executed, as illustrated in FIG. 8A, an electronic device 800 can move a currently displayed page screen 810 to another page screen 820, as illustrated in FIG. 8B. For example, the electronic device 800 can move to a specific page 820 or can sequentially move a configured bookmark, according to the pattern of the detected knock.

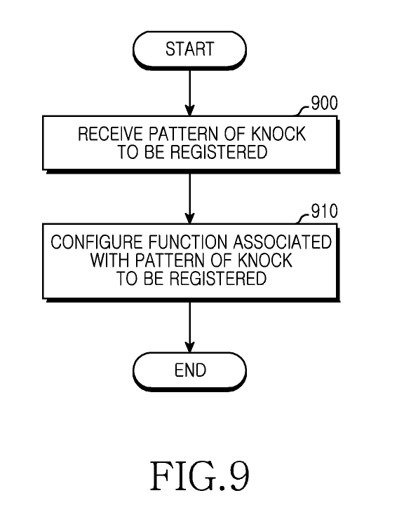

FIG. 9 is a flowchart illustrating a process of registering a pattern of knocks in an electronic device, according to an embodiment of the present disclosure.

Referring to FIG. 9, in step 900, an electronic device 100 can receive a knock pattern to be registered. A user can input a knock on a predetermined area of the electronic device 100. A user can input the specific number of knocks and a specific period of knocks, in order to configure the knock pattern. For example, the electronic device 100 can acquire a knock pattern including at least one of the number of knocks, the period of the knocks, and the intensity of the knocks. The electronic device 100 can store acceleration information and sound information which are acquired on the basis of at least one of the number of input knocks, the period of the input knocks, and the intensity of the input knocks, using a microphone module and an acceleration sensor. According to an embodiment, when an first input knock pattern is the same as a second input knock pattern, the electronic device 100 configures the knock pattern as a reference knock pattern.

In step 910, the electronic device 100 can configure a function associated with a knock pattern to be registered. The electronic device 100 can configure various functions to be performed according to an input knock pattern. For example, such a function may include a lock screen releasing function, a call transmission/reception function, or a specific application execution function, but is not limited thereto, and may further include various functions to be applied.

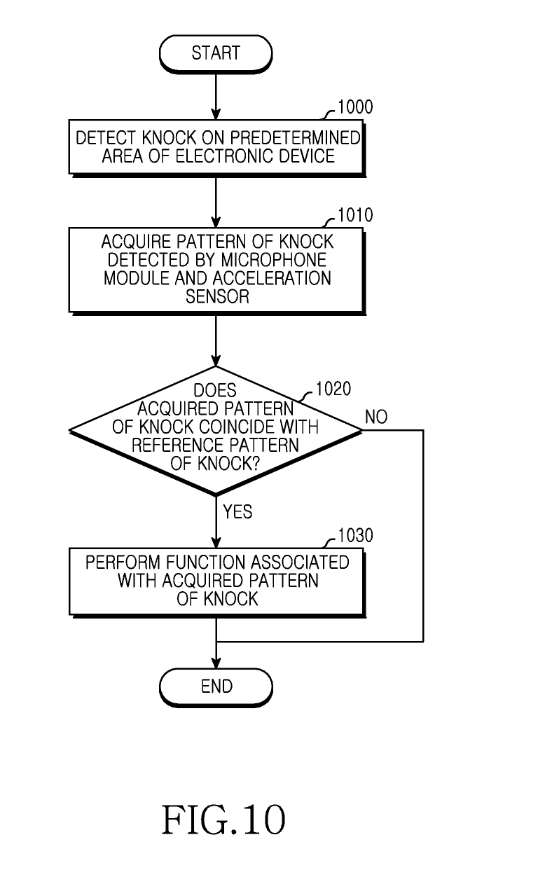

FIG. 10 is a flowchart illustrating a process of performing a function associated with a pattern of knocks detected in an electronic device according to an embodiment of the present disclosure.

Referring to FIG. 10, in step 1000, an electronic device 100 can detect a knock on a predetermined area of the electronic device 100. The electronic device 100 can detect a contact, collision, or shock with an object in a predetermined area of the electronic device 100. The electronic device 100 can detects a sound wave generated by a vibration according to the contact, collision, or shock with an object in a predetermined area. The electronic device 100 can detect a knock generated by a predetermined object, as well as by a user's finger.

In step 1010, the electronic device 100 can acquire a pattern of knocks detected by the microphone module and the acceleration sensor. The electronic device 100 can acquire a knock pattern including at least one of the number of knocks, the period of the knocks, and the intensity of the knocks. For example, the electronic device 100 can acquire acceleration information and sound information which are acquired on the basis of at least one of the number of input knocks, the period of the input knocks, and the intensity of the input knocks, using a microphone module and an acceleration sensor.

In step 1020, the electronic device 100 can determine whether the acquired knock pattern corresponds to a reference knock pattern. The electronic device 100 can compare the acquired knock pattern with a pre-registered reference knock pattern. For example, the electronic device 100 can determine whether the acquired knock pattern corresponds to the reference knock pattern at a threshold ratio or higher.

When the acquired knock pattern corresponds to the reference knock pattern, the electronic device 100 can perform a function associated with the acquired knock pattern, in step 1030. For example, when recognizing an input knock pattern, the electronic device 100 can perform a lock screen releasing function, a call reception/transmission function, a specific application executing function, etc. The electronic device 100 can register at least one specific knock pattern, and configure a function associated with each specific knock pattern.

A method of operating an electronic device according to various embodiments may include detecting a knock on a predetermined area of the electronic device, analyzing a pattern of the detected knock, and performing a function associated with the analyzed pattern.

According to various embodiments, detecting the knock may include detecting vibration of sound waves of the knock using the acceleration sensor module or the microphone module.

According to various embodiments, detecting the knock may include detecting at least one of the number of the knock, the period of the knock, and the intensity of the knock.

According to various embodiments, detecting the knock may include detecting a knock in an idle state of the electronic device.

According to various embodiments, analyzing a pattern of the detected knock may include determining whether the pattern of the detected knock corresponds to a reference pattern of a knock.

According to various embodiments, determining whether the pattern of the detected knock corresponds to the reference pattern of a knock is based on whether acceleration information and sound information of the pattern of the detected knock corresponds to a reference acceleration information and reference sound information of the reference pattern of knock.

According to various embodiments, determining whether the pattern of the detected knock corresponds to a reference pattern of a knock is based on whether the pattern of the detected knock corresponds to the reference pattern of a knock at a threshold ratio or higher.

According to various embodiments, performing the function may include performing at least one of a lock screen releasing function, a call reception/transmission function, a specific application executing function, etc.

According to various embodiments, the method may further include receiving a knock pattern to be registered and configuring a function associated with the knock pattern to be registered.

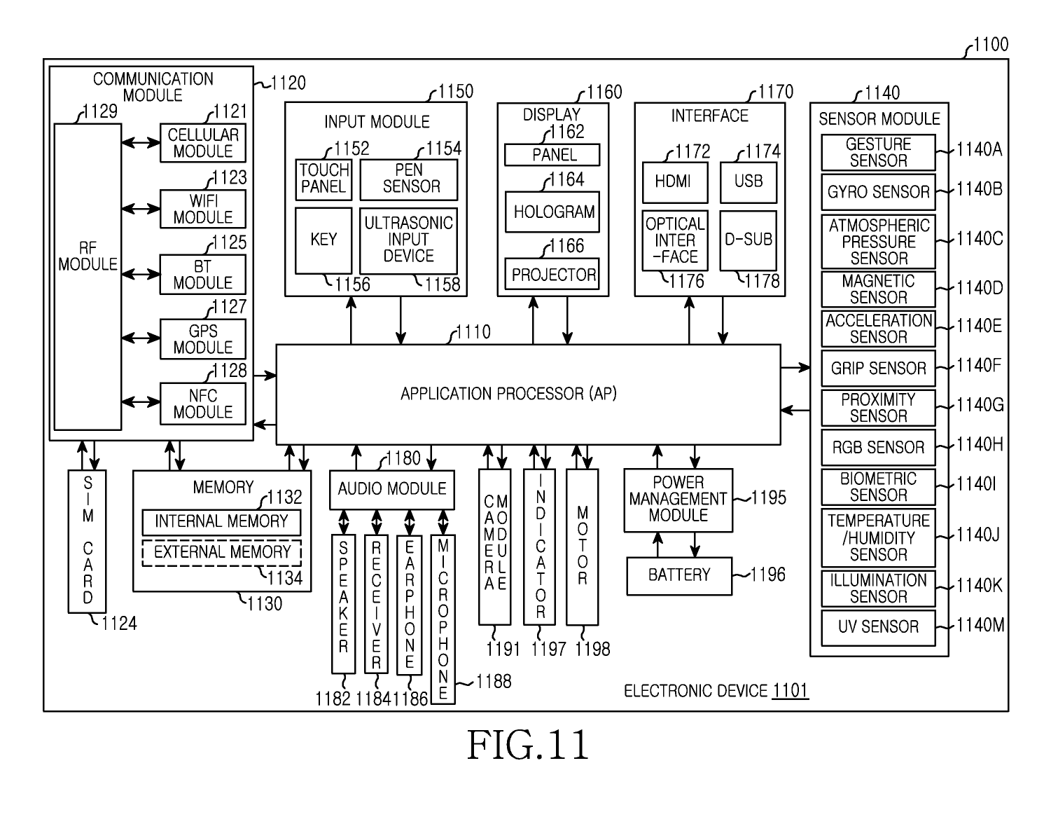

FIG. 11 is a block diagram 1100 illustrating an electronic device 1101 according to various embodiments of the present disclosure. The electronic device 1101 configures, for example, the whole or a part of the electronic device 100 illustrated in FIG. 1.

Referring to FIG. 11, the electronic device 1101 may include one or more of an Application Processor (AP) 1110, a communication module 1120, a Subscriber Identification Module (SIM) card 1124, a memory 1130, a sensor module 1140, an input device 1150, a display 1160, an interface 1170, an audio module 1180, a camera module 1191, a power managing module 1195, a battery 1196, an indicator 1197, and a motor 1198.

The AP 1110 can control a plurality of hardware or software components connected to the AP 1110 by driving an operating system or an application program and can process and calculate various pieces of data including multimedia data. The AP 1110 may be implemented by, for example, a System on Chip (SoC). According to an embodiment, the AP 1110 may further include a Graphic Processing Unit (GPU).

The communication module 1120 may perform data transmission/reception in communication between other electronic devices (e.g., the electronic device 104 or the server 106) connected to electronic device 1101 (e.g., the electronic device 100) through the network. According to an embodiment, the communication module 1120 may include a cellular module 1121, a Wi-Fi module 1123, a BT module 1125, a GPS module 1127, an NFC module 1128, and a Radio Frequency (RF) module 1129.

The cellular module 1121 may provide a voice call, a video call, a Short Message Service (SMS), an Internet service, etc., through a communication network (e.g., LTE, LTE-A, CDMA, WCDMA, UMTS, WiBro, GSM, etc.). Further, the cellular module 1121 may distinguish and authenticate electronic devices within a communication network, using, for example, a subscriber identification module (e.g., the SIM card 1124). According to an embodiment, the cellular module 1121 may perform at least some functions which the AP 1110 may provide. For example, the cellular module 1121 may perform at least a part of the multimedia control functions.

According to an embodiment, the cellular module 1121 may include a Communication Processor (CP). Further, the cellular module 1121 may be implemented by, for example, an SoC. Although the components such as the cellular module 1121 (e.g., a communication processor), the memory 1130, the power managing module 1195, etc. are illustrated as components separate from the AP 1410 in FIG. 11, according to an embodiment, the AP 1110 may include at least a part of the aforementioned components (e.g., the cellular module 1110).

According to an embodiment, the AP 1110 or the cellular module 1121 (e.g., the communication processor) may load a command or data received from at least one of a non-volatile memory and other elements connected thereto in a volatile memory, and may process the loaded command or data. Further, the AP 1110 or the cellular module 1121 may store data received from or generated by at least one of other elements in a non-volatile memory.

Each of the Wi-Fi module 1123, the BT module 1125, the GPS module 1127, and the NFC module 1128 may include, for example, a processor for processing data transmitted/received through the corresponding module. In FIG. 11, the cellular module 1121, the Wi-Fi module 1123, the BT module 1125, the GPS module 1127, and the NFC module 1128 are illustrated as separate blocks, but at least a part (e.g., two or more) of the cellular module 1121, the Wi-Fi module 1123, the BT module 1125, the GPS module 1127, and the NFC module 1128 may be included in one Integrated Chip (IC) or one IC package. For example, at least a part (e.g., the communication processor corresponding to the cellular module 1121 and the Wi-Fi processor corresponding to the Wi-Fi module 1123) of the processors corresponding to the cellular module 1125, the Wi-Fi module 1127, the BT module 1128, the GPS module 1121, and the NFC module 1123 may be implemented as one SoC.

The RF module 1129 may transmit and receive data, for example, an RF signal. The RF module 1129 may include, for example, a transceiver, a Power Amp Module (PAM), a frequency filter, a Low Noise Amplifier (LNA), etc. Further, the RF module 1129 may further include a component for transmitting/receiving electronic waves over a free air space in wireless communication, for example, a conductor, a conducting wire, etc. Although the cellular module 1121, the Wi-Fi module 1123, the BT module 1125, the GPS module 1127, and the NFC module 1128 share one RF module 1129 in FIG. 11, according to an embodiment, at least one of the cellular module 1121, the Wi-Fi module 1123, the BT module 1125, the GPS module 1127, and the NFC module 1128 may transmit/receive an RF signal through a separate RF module.

The SIM card 1124 may be inserted into a slot formed in a particular portion of the electronic device 1101. The SIM card 1124 may include unique identification information (e.g., an Integrated Circuit Card IDentifier (ICCID)) or subscriber information (e.g., an International Mobile Subscriber IDentity (IMSI)).

The memory 1130 (e.g., the memory 130) may include an internal memory 1132 or an external memory 1134. The internal memory 1132 may include at least one of a volatile memory (e.g., a Dynamic Random Access Memory (DRAM), a Static RAM (SRAM), a Synchronous Dynamic RAM (SDRAM), etc.) and a non-volatile memory (e.g., a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a NAND flash memory, a NOR flash memory, etc.).

The internal memory 1132 may be a Solid State Drive (SSD). The external memory 1134 may further include a flash drive, e.g., a Compact Flash (CF), a Secure Digital (SD), a Micro Secure Digital (Micro-SD), a Mini Secure Digital (Mini-SD), an extreme Digital (xD), a memory stick, etc.

The external memory 1134 may be functionally connected with the electronic device 1101 through various interfaces.

The electronic device 1101 may further include a storage device (or a storage medium) such as a hard disc drive.

The sensor module 1140 can measure a physical quantity or detect an operation state of the electronic device 1101, and can convert the measured or detected information to an electrical signal. The sensor module 1140 may include, for example, at least one of a gesture sensor 1140A, a gyro sensor 1140B, an atmospheric pressure sensor 1140C, a magnetic sensor 1140D, an acceleration sensor 1140E, a grip sensor 1140F, a proximity sensor 1140G, a color sensor 1140H (for example, Red, Green, and Blue (RGB) sensor), a biometric sensor 1140I, a temperature/humidity sensor 1140J, an illumination sensor 1140K, and a Ultra Violet (UV) sensor 1140M. Additionally or alternatively, the sensor module 1140 may include, for example, an E-nose sensor, an electromyography (EMG) sensor, an electroencephalogram (EEG) sensor, an electrocardiogram (ECG) sensor, an Infrared (IR) sensor, an iris sensor, a fingerprint sensor, etc. The sensor module 1140 may further include a control circuit for controlling one or more sensors included in the sensor module 1440.

The input device 1150 may include a touch panel 1152, a (digital) pen sensor 1154, a key 1156, or an ultrasonic input device 1158. The touch panel 1152 may recognize a touch input by at least one of, for example, a capacitive type, a pressure type, an infrared type, or an ultrasonic type. Further, the touch panel 1152 may further include a control circuit. The capacitive scheme touch panel may recognize physical contact or proximity. The touch panel 1152 may further include a tactile layer. In this case, the touch panel 1152 may provide a tactile reaction to a user.

The (digital) pen sensor 1154 may be embodied, for example, using a method identical or similar to a method of receiving a touch input of a user, or using a separate recognition sheet.

The key 1156 may include, for example, a physical button, an optical key, or a keypad.

The ultrasonic input device 1158 can identify data by detecting an acoustic wave using a microphone 1188 of the electronic device 1101 through an input tool generating an ultrasonic signal, and can perform wireless recognition. According to an embodiment, the electronic device 1101 may receive a user input from an external device (for example, computer or server) connected thereto using the communication module 1120.

The display 1160 may include a panel 1162, a hologram device 1164 or a projector 1166.

The panel 1162 may be, for example, a Liquid Crystal Display (LCD) or an Active Matrix Organic Light Emitting Diode (AM-OLED). The panel 1162 may be implemented to be, for example, flexible, transparent, or wearable. The panel 1162 may be configured as one module together with the touch panel 1152.

The hologram device 1164 may show a stereoscopic image in the air using interference of light.

The projector 1166 may project light onto a screen to display an image. The screen may be located, for example, inside or outside the electronic device 1101. The display 1160 may further include a control circuit for controlling the panel 1162, the hologram device 1164, or the projector 1166.

The interface 1170 may include, for example, a High-Definition Multimedia Interface (HDMI) 1172, a Universal Serial Bus (USB) 1174, an optical interface 1176, or a D-subminiature (D-sub) 1178. The interface 1170 may be included in, for example, the communication interface 160 illustrated in FIG. 1. Additionally or alternatively, the interface 1170 may include, for example, a Mobile High-definition Link (MHL) interface, a Secure Digital (SD) card/Multi-Media Card (MMC) interface, or an Infrared Data Association (IrDA) standard interface.

The audio module 1180 may bilaterally convert a sound and an electronic signal. The audio module 1180 may process sound information input or output through, for example, the speaker 1182, the receiver 1184, the earphone 1186, the microphone 1188 or the like.

The camera module 1191 is a device for capturing a still image or a video, and may include one or more image sensors (e.g., a front sensor or a rear sensor), a lens, an Image Signal Processor (ISP), or a flash (e.g., an LED or xenon lamp).

The power managing module 1195 may manage power of the electronic device 1101. The power managing module 1195 may include, for example, a Power Management Integrated Circuit (PMIC), a charger Integrated Circuit (IC), or a battery gauge. The PMIC may be mounted to, for example, an integrated circuit or an SoC semiconductor.

The charging schemes may be classified into a wired type and a wireless type. The charger IC may charge a battery, and may prevent introduction of over-voltage or over-current from a charger. The charger IC may include a charger IC for at least one of the wired charging scheme and the wireless charging scheme. The wireless charging scheme may be one of a magnetic resonance scheme, a magnetic induction scheme, or an electromagnetic scheme. An additional circuit for wireless charging, such as a coil loop circuit, a resonance circuit, a rectifier circuit, and the like may be added.

The battery gauge may measure, for example, a remaining quantity of the battery 1196, or a voltage, a current, or a temperature during the charging. The battery 1196 may store or generate electricity, and may supply power to the electronic device 1101 using the stored or generated electricity. The battery 1196 may include, for example, a rechargeable battery or a solar battery.

The indicator 1197 may display a specific state of the electronic device 1101 or a part (for example the AP 1110) of the electronic device 1101, for example, a booting state, a message state, a charging state, etc. The motor 1198 may convert an electrical signal into a mechanical vibration. The electronic device 1101 may include a processing unit (for example, a GPU) for supporting mobile TV. The processing device for supporting mobile TV may process media data according to standards such as, for example, a Digital Multimedia Broadcasting (DMB), a Digital Video Broadcasting (DVB) or a media flow.

The above described components of the electronic device 1101 according to various embodiments of the present disclosure may be formed of one or more components, and a name of a corresponding component element may be changed based on the type of electronic device. The electronic device 1101, according to embodiments of the present disclosure, may include one or more of the aforementioned components or may further include other additional components, or some of the aforementioned components may be omitted. Further, some of the components of the electronic device 1101, according to the various embodiments of the present disclosure, may be combined to form a single entity, and thus, may equivalently execute functions of the corresponding elements prior to the combination.

The term “module” used in various embodiments of the present disclosure may refer to, for example, a “unit” including one of hardware, software, and firmware, or a combination of two or more of the hardware, software, and firmware. The term “module” may be interchangeably used with a term, such as unit, logic, logical block, component, or circuit. The “module” may be the smallest unit of an integrated component or a part thereof. The “module” may be the smallest unit that performs one or more functions or a part thereof. The “module” may be mechanically or electronically implemented. For example, the “module”, according to various embodiments of the present disclosure, may include at least one of an Application-Specific Integrated Circuit (ASIC) chip, a Field-Programmable Gate Arrays (FPGAs), and a programmable-logic device for performing operations which have been known or are to be developed hereafter.

According to various embodiments of the present disclosure, at least some of the devices (for example, modules or functions thereof) or the method (for example, operations) according to the present disclosure may be implemented by a command stored in a computer-readable storage medium in a programming module form. When the command is executed by one or more processors (for example, the processor 120), the one or more processors may execute a function corresponding to the command. The computer-readable storage medium may be, for example, the memory 130. At least a part of the programming module may be implemented (for example, executed) by, for example, the processor 120. At least some of the programming modules may include, for example, a module, a program, a routine, a set of instructions or a process for performing one or more functions.

The computer readable recoding medium may include magnetic media, such as a hard disk, a floppy disk and a magnetic tape, optical media, such as a Compact Disc Read Only Memory (CD-ROM) and a Digital Versatile Disc (DVD), magneto-optical media, such as a floptical disk, and a hardware device specially configured to store and execute a program instruction (for example, a programming module), such as a Read Only Memory (ROM), a Random Access Memory (RAM), a flash memory, and the like. In addition, the program instructions may include high class language codes, which can be executed in a computer by using an interpreter, as well as machine codes made by a compiler. The aforementioned hardware device may be configured to operate as one or more software modules in order to perform the operation of various embodiments of the present disclosure, and vice versa.

A module or a programming module according to the present disclosure may include at least one of the described component elements, a few of the component elements may be omitted, or additional component elements may be included. Operations executed by a module, a programming module, or other component elements, according to various embodiments of the present disclosure, may be executed sequentially, in parallel, repeatedly, or in a heuristic manner. Further, some operations may be executed according to another order or may be omitted, or other operations may be added.

According to various embodiments of the present disclosure, a storage medium for storing commands is provided, the commands being configured to perform at least one operation when being executed by at least one processor, the at least one operation including detecting a knock on a predetermined area of an electronic device, analyzing a pattern of the detected knock, and performing a function associated with the analyzed pattern.

The embodiments of the present disclosure disclosed in this specification and drawings are only particular examples provided in order to easily describe the technical matters of the present disclosure and help with comprehension of the present disclosure, and do not limit the scope of the present disclosure. It will be understood by those skilled in the art that various changes in form and detail may be made therein without departing from the spirit and scope of the disclosure as defined by the appended claims and their equivalents.

What is claimed is:

1. A method of operating an electronic device, the method comprising:
detecting a knock on a predetermined area of the electronic device;
analyzing a pattern of the detected knock; and
performing a function associated with the analyzed pattern.

2. The method of claim 1, wherein detecting the knock comprises detecting a vibration or a sound wave of the knock through an acceleration sensor module or a microphone module.

3. The method of claim 1, wherein detecting the knock comprises detecting at least one of the number of the knocks, a period of the knocks, and an intensity of the knocks.

4. The method of claim 1, wherein detecting the knock comprises detecting the knock in an idle state of the electronic device.

5. The method of claim 1, wherein analyzing a pattern of the detected knock comprises determining whether the pattern of the detected knock corresponds to a reference pattern of a knock.

6. The method of claim 5, wherein determining whether the pattern of the detected knock corresponds to the reference pattern of a knock is based on whether acceleration information and sound information of the pattern of the detected knock corresponds to reference acceleration information and reference sound information of the reference pattern of a knock.

7. The method of claim 5, wherein determining whether the pattern of the detected knock corresponds to a reference pattern of a knock is based on whether the pattern of the detected knock corresponds to the reference pattern of a knock at a threshold ratio or higher.

8. The method of claim 1, wherein performing the function comprises performing at least one of a lock screen releasing function, a call reception/transmission function, and a specific application executing function.

9. The method of claim 1, further comprising:
receiving a pattern of a knock to be registered; and
configuring a function associated with the pattern of a knock to be registered.

10. An electronic device comprising:
an acceleration sensor module;
a microphone module; and
a processor configured to analyze a pattern of a knock, detected by at least one of the acceleration sensor module and the microphone module, to perform a function associated with the pattern.

11. The electronic device of claim 10, wherein the processor is further configured to control to detect at least one of the number of the knock, a period of the knock, and an intensity of the knock.

12. The electronic device of claim 10, wherein the processor is further configured to control to detect the knock in an idle state of the electronic device.

13. The electronic device of claim 12, wherein the processor is further configured to determine whether the pattern of a knock corresponds to a reference pattern of a knock.

14. The electronic device of claim 13, wherein the processor is further configured to determine whether acceleration information and sound information of the pattern of a knock correspond to reference acceleration information and reference sound information of the reference pattern of a knock.

15. The electronic device of claim 13, wherein the processor is further configured to determine whether the pattern of a knock corresponds to the reference pattern of a knock at a threshold ratio or higher.

16. The electronic device of claim 10, wherein the function comprises at least one of a lock screen releasing function, a call receiving/transmitting function, and a specific application executing function.

17. The electronic device of claim 10, wherein the processor is further configured to receive a pattern of a knock to be registered and configure a function associated with the pattern of a knock to be configured.

18. A non-transitory computer-readable recording medium for storing a program for performing a method, the method comprising:
detecting a knock in a predetermined area of an electronic device;
analyzing a pattern of the detected knock; and
performing a function associated with the analyzed pattern.
